(19) United States
(12) Patent Application Publication
(10) Pub. No.: US 2024/0033917 A1
(43) Pub. Date: Feb. 1, 2024

(54) CELL DIRECTING APPARATUS AND ROBOT FOR ASSISTING PICKING

(71) Applicant: Floatic Inc., Seoul (KR)

(72) Inventors: Sucheol Lee, Seoul (KR); Hoyeon Yu, Seoul (KR); Seokhoon Jeong, Seoul (KR); Seung Hoon Lee, Seoul (KR)

(21) Appl. No.: 18/226,003

(22) Filed: Jul. 25, 2023

(30) Foreign Application Priority Data
Jul. 26, 2022 (KR) 10-2022-0092332

(51) Int. Cl. B25J 9/16

(52) U.S. Cl. CPC B25J 9/1664

(57) ABSTRACT

Provided is a driving robot, including a transceiver configured to communicate with an external device, a driving actuator configured to the driving robot to move along a driving path, a spotlight illuminator configured to guide a user to a location of a cell having a target object to be picked by a user, an illumination actuator configured to adjust a pointing direction of the spotlight illuminator, and one or more controllers configured to control the driving actuator, the spotlight illuminator and the illumination actuator.

### CROSS-REFERENCE TO RELATED APPLICATION

This application claims priority to Korean Patent Application No. 10-2022-0092332, filed in the Korean Intellectual Property Office on Jul. 26, 2022, the entire contents of which are hereby incorporated by reference.

### TECHNICAL FIELD

The present disclosure relates to a cell directing apparatus and a robot for assisting picking, and specifically, to a cell directing apparatus for assisting a user (cooperator) with picking items by pointing at a cell having a target object to be picked (hereinafter, “target object”), and a driving robot equipped with the cell directing apparatus.

### BACKGROUND

“Picking” may refer to an operation of taking out or bringing a target object from a place in a distribution warehouse where the target object is stored. In general, the distribution warehouse includes a plurality of racks, and the racks include a plurality of cells. A worker who performs picking has to check which cell of which rack the target object is placed, and take the target object from the cell having the target object. However, when the worker directly checks the location information of the location of the cell having the target object and finds the cell and takes the target object, there is a problem in that the picking process is delayed.

Accordingly, a digital picking system for efficient picking has been proposed. According to the digital picking system, a control indicator (lamp) is attached to each cell in the rack such that the lamp on the control indicator attached to the cell having a target object to be picked by the worker flickers, thereby improving the picking efficiency.

However, in order to build a digital picking system, it is necessary to install digital indicators in all cells of the racks in the distribution warehouse, resulting in a problem of increasing cost and time for equipment replacements. In addition, since the rack having a digital display installed thereon is optimized for the purpose of picking, it is difficult to utilize it for other purposes.

### SUMMARY

The present disclosure provides a cell directing apparatus for solving the problems described above, a system, and a driving robot equipped with the cell directing apparatus.

The present disclosure may be implemented in a variety of ways, including a method, an apparatus (system, robot, etc.), or a non-transitory computer-readable recording medium storing instructions.

A driving robot may include a transceiver configured to communicate with an external device, a driving actuator configured to the driving robot to move along a driving path, a spotlight illuminator configured to guide a user to a location of a cell having a target object to be picked by a user, an illumination actuator configured to adjust a pointing direction of the spotlight illuminator, and one or more controllers configured to control the driving actuator, the spotlight illuminator and the illumination actuator.

The one or more controllers may be further configured to receive location information of the location of the cell having the target object from the external device via the transceiver, determine a pickup location based on the location information of the location of the cell, and control the driving actuator such that the driving robot moves to the determined pickup location.

The one or more controllers may be further configured to receive location information of the location of the cell having the target object from the external device via the transceiver, control the illumination actuator such that the spotlight illuminator points at the location of the cell based on the location information of the location of the cell, and current location information of the driving robot and current posture information of the driving robot, and control the spotlight illuminator to on state.

The current location information of the driving robot may be location information estimated by the driving robot or the external device.

The one or more controllers may be configured to control the illumination actuator further based on relative location information between the driving actuator and the spotlight illuminator.

The one or more controllers may be configured to control the illumination actuator further based on current posture information of the spotlight illuminator.

The location information of the location of the cell may include a coordinate value in a global coordinate system, the current location information of the driving robot may include a coordinate value in the global coordinate system, and the controllers may be further configured to calculate local location information indicating the location of the cell having the target object in a local coordinate system which is a self-coordinate system of the driving robot, wherein the local location information is calculated based on the location information of the location of the cell, the current location information of the driving robot, and the current posture information of the driving robot, and control the illumination actuator such that the spotlight illuminator points at the location of the cell based on the calculated local location information.

The illumination actuator may include a first actuator configured to be rotated about a first rotation axis under a control of the one or more controllers, and a second actuator configured to be rotated about a second rotation axis under the control of the one or more controllers, and the one or more controllers may be further configured to calculate a first rotation angle of the first actuator and a second rotation angle of the second actuator based on the local location information, rotate the first actuator by the first rotation angle, and rotate the second actuator by the second rotation angle.

The driving robot may further include a barcode scanner and a user interface configured to receive a user input, and the one or more controllers may be further configured to, after controlling the spotlight illuminator to the on state, receive barcode data associated with the target object from the barcode scanner, and based on the user input, complete picking the target object.

A mobile cell directing apparatus may include a spotlight illuminator configured to guide a user to a location of a cell having a target object to be picked by a user, an illumination actuator configured to adjust a pointing direction of the spotlight illuminator, and one or more controllers configured to control the spotlight illuminator and the illumination actuator, in which the controllers may be configured to receive location information of the location of the cell having the target object from the driving robot, receive a current location information of the driving robot from the driving robot, receive current posture information of the driving robot from the driving robot, control the illumination actuator such that the spotlight illuminator points at the location of the cell based on the location information of the location of the cell, the current location information of the driving robot, the current posture information of the driving robot, and relative location information between the driving robot and the cell directing apparatus, and control the spotlight illuminator to on state.

By illuminating and pointing at the target object to be picked by the user, it is possible to intuitively guide to the target object, thereby improving the efficiency of picking.

It is possible to improve the efficiency of picking by utilizing existing equipment while minimizing infrastructure replacement costs without replacing existing logistics equipment (e.g., racks).

By converting location information of the location of the cell into local location information based on the cell directing apparatus or the driving robot, it is possible to point at the target cell even if the location of the cell directing apparatus or the driving robot is not fixed and changes.

The effects of the present disclosure are not limited to the effects described above, and other effects not described herein can be clearly understood by those of ordinary skill in the art (referred to as “ordinary technician”) from the description of the claims.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 illustrates an example of a driving robot equipped with a cell directing apparatus;

FIG. 2 schematically illustrates a configuration in which an information processing system is communicatively connected to a plurality of driving robots;

FIG. 3 is a block diagram of an internal configuration of a driving robot equipped with a cell directing apparatus;

FIG. 4 is a block diagram of internal configurations of a driving robot and a cell directing apparatus;

FIG. 5 illustrates an example in which a driving robot equipped with a cell directing apparatus moves to a pickup location to assist picking of a target object;

FIG. 6 illustrates an example of a method for calculating local location information of a cell and calculating a rotation angle of an illumination actuator based on the location information of the location of the cell;

FIG. 7 illustrates an example of a cell directing apparatus;

FIG. 8 illustrates an example in which a driving robot equipped with a cell directing apparatus assists a user with picking; and

FIG. 9 is a flowchart illustrating an example of a method for assisting a user with picking.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but not limited thereto. For example, the system may include one or more server devices. In another example, the system may include one or more cloud devices. In still another example, the system may include both the server device and the cloud device operated in conjunction with each other.

In the present disclosure, a “display” may refer to any display device associated with a driving robot, a cell directing apparatus, and/or an information processing system, and, for example, it may refer to any display device that is controlled by the driving robot, the cell directing apparatus and/or the information processing system or that is capable of displaying any information/data provided from the driving robot, the cell directing apparatus and/or the information processing system.

In the present disclosure, “each of a plurality of A” may refer to each of all components included in the plurality of A, or may refer to each of some of the components included in a plurality of A.

In the present disclosure, terms such as first, second, etc. are only used to distinguish certain components from other components, and the nature, sequence, order, and the like of the components are not limited by the terms.

In the present disclosure, if a certain component is stated as being “connected”, “combined” or “coupled” to another component, it is to be understood that there may be yet another intervening component “connected”, “combined” or “coupled” between the two components, although the two components may also be directly connected, combined or coupled to each other.

In the present disclosure, as used in the following examples, “comprise” and/or “comprising” does not foreclose the presence or addition of one or more other elements, steps, operations, and/or devices in addition to the recited elements, steps, operations, or devices.

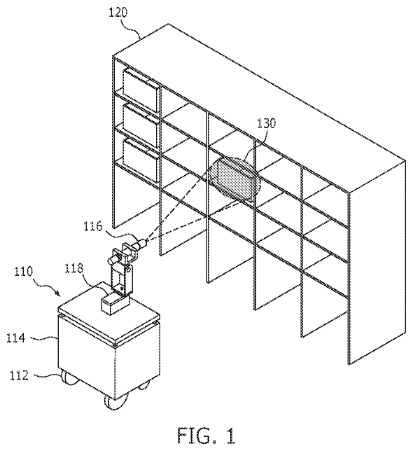

FIG. 1 illustrates an example of a driving robot 110 equipped with a cell directing apparatus. The driving robot 110 equipped with the cell directing apparatus may assist the user (collaborator) with picking. The term “picking” as used herein may refer to an operation of taking out or bringing a target object from a place in the distribution warehouse where the target object is stored, and the term “user” may refer to a worker who performs the picking operation. For example, the driving robot 110 may move to a pickup location near a rack 120 including a cell 130 having a target object. The driving robot 110 points to the cell 130 having the target object with spotlight illuminator 116 so as to intuitively notify the user of the location of the target object, thereby improving the work efficiency of the user.

The driving robot 110 equipped with the cell directing apparatus may include a driving actuator 112, a loading unit 114, the spotlight illuminator 116, and an illumination actuator 118.

The driving actuator 112 may be configured to move the driving robot 110 along a driving path or the like. The driving actuator 112 may include wheels to which driving power is supplied and/or wheels to which power is not supplied. The control unit may control the driving actuator 112 such that the driving robot 110 moves to a pickup location near the rack 120.

The loading unit 114 may be configured to load or store objects picked by the user. For example, the user may take out a target object from the cell 130 having the target object and load the target object into the loading unit 114. The loading unit 114 may be configured in various shapes and sizes as needed.

The spotlight illuminator 116 is a light that intensively illuminates light on a certain area to emphasize the area, and may be configured to illuminate the cell 130 having the target object to visually guide the user to the location of the cell 130. The control unit may control the spotlight illuminator 116 such that the spotlight illuminator 116 is on (the light is turned on) or off (the light is turned off).

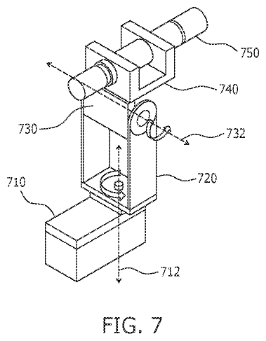

The illumination actuator 118 may be configured to adjust a pointing direction of the spotlight illuminator 116. For example, the illumination actuator 118 may be configured to be directly or indirectly connected to the spotlight illuminator 116 such that the spotlight illuminator 116 points at a specific location according to the actuation of the illumination actuator 118. The control unit may control the operation of the illumination actuator 118 to adjust the pointing direction of the spotlight illuminator 116. Specific examples of the configuration and operation of the illumination actuator 118 will be described below in detail with reference to FIG. 7.

The driving robot 110 equipped with the cell directing apparatus illustrated in FIG. 1 is merely an example for implementing the present disclosure, and the scope of the present disclosure is not limited thereto and may be implemented in various ways. For example, although a driving robot that moves using wheels is illustrated as an example in FIG. 1, a driving robot including a driving actuator of various types, such as a drone or a biped walking robot, may be included in the present disclosure. As another example, the driving robot equipped with the cell directing apparatus may not include the loading unit 114, and a device (e.g., a logistics transport robot) for loading and transporting objects picked by the user may be configured separately from the driving robot 110. As another example, instead of integrally configuring the driving robot 110 equipped with the cell directing apparatus, the cell directing apparatus including the spotlight illuminator 116 and the illumination actuator 118 and the driving robot including the driving actuator 112 may be configured as separate devices, and the devices may be combined and used to assist picking.

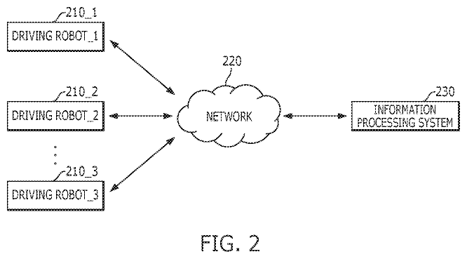

FIG. 2 schematically illustrates a configuration in which an information processing system 230 is communicatively connected to a plurality of driving robots 210_1, 210_2, and 210_3. As illustrated, the plurality of driving robots 210_1, 210_2, and 210_3 may be connected to the information processing system 230 through a network 220.

Each of the plurality of driving robots 210_1, 210_2, and 210_3 may include a cell directing apparatus that assists the user with picking items by pointing at a cell. Alternatively, the driving robots 210_1, 210_2, and 210_3 not equipped with a cell directing apparatus may be combined with a separate cell directing apparatus to assist the user with picking.

The information processing system 230 may include one or more server devices and/or databases, or one or more distributed computing devices and/or distributed databases based on cloud computing services, which can store, provide and execute computer-executable programs (e.g., downloadable applications) and data associated with the logistics management.

The plurality of driving robots 210_1, 210_2, and 210_3 may communicate with the information processing system 230 through the network 220. The network 220 may be configured to enable communication between the plurality of driving robots 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, and the like) that may be included in the network 220 as well as short-range wireless communication between the driving robots 210_1, 210_2, and 210_3, but aspects are not limited thereto. FIG. 2 illustrates that three driving robots 210_1, 210_2, and 210_3 are in communication with the information processing system 230 through the network 220, but aspects are not limited thereto, and a different number of driving robots may be configured to be in communication with the information processing system 230 through the network 220.

The driving robot 210 may receive, from the information processing system 230, location information of location of a cell having a target object. The driving robot 210 may determine a pickup location to assist picking the target object and move to the pickup location. The driving robot 210 may assist the user with picking, by pointing at a cell having the target object with spotlight illuminator. Additionally, the driving robot 210 may receive a user input indicating the completion of picking objects and transmit the received input to the information processing system 230. The information processing system 230 may transmit the location of the cell having the next target object to the driving robot 210 so that the driving robot 210 assists picking the next target object, or transmit information indicating the completion of picking to the driving robot 210 so that the driving robot 210 ends the picking assisting operation.

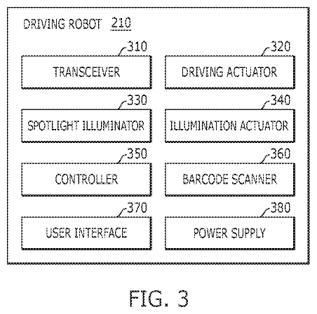

FIG. 3 is a block diagram of an internal configuration of the driving robot 210 equipped with the cell directing apparatus. As illustrated, the driving robot 210 may include a transceiver 310, a driving actuator 320, a spotlight illuminator 330, an illumination actuator 340, a control unit 350, a barcode scanner 360, a use interface 370, and a power supply unit 380.

The transceiver 310 may provide a configuration or function for enabling communication between the driving robot 210 and the information processing system through a network, and may provide a configuration or function for enabling communication between the driving robot 210 and another driving robot or another device/system (e.g., a separate cloud system, etc.) For example, a request or data generated by the control unit 350 of the driving robot 210 (e.g., a request for location information of location of a cell having a target object, etc.) may be transmitted to the information processing system through a network under the control of the transceiver 310. Conversely, a control signal or command provided by the information processing system may be received by the driving robot 210 via the transceiver 310 of the driving robot 210 through a network. For example, the driving robot 210 may receive the location information, etc. of a cell having a target object from the information processing system via the transceiver 310.

The driving actuator 320 may be configured to move the driving robot 210 along a driving path or the like. The driving actuator 320 may include wheels to which driving power is supplied and/or wheels to which power is not supplied. The driving actuator 320 may control the driving robot 210 under the control of the control unit 350 so that the driving robot 210 moves to a specific location (e.g., pickup location, etc.)

The spotlight illuminator 330 may be a light that intensively illuminates light on a partial area to emphasize that area. The pointing direction of the spotlight illuminator 330 may be changed according to driving of the illumination actuator 340 so that the cell having the target object is illuminated. The spotlight illuminator 330 may be configured to be changed between on state (where light is turned on) and off state (where light is turned off) under the control of the control unit 350.

Under the control of the control unit 350, the illumination actuator 340 may be driven to adjust the pointing direction of the spotlight illuminator 330. For example, the illumination actuator 340 may be directly or indirectly coupled to the spotlight illuminator 330 and controlled such that the spotlight illuminator 330 points at a specific location according to the actuation of the illumination actuator 340.

The driving robot 210 may include a plurality of actuators. For example, the illumination actuator 340 may include a first actuator configured to be rotated about a first rotation axis, and a second actuator configured to be rotated about a second rotation axis different from the first rotation axis. In this case, the spotlight illuminator 330 may point at any direction in space according to the rotation of the first actuator and the second actuator. Specific examples of the configuration and operation of the illumination actuator 340 will be described below in detail with reference to FIG. 7.

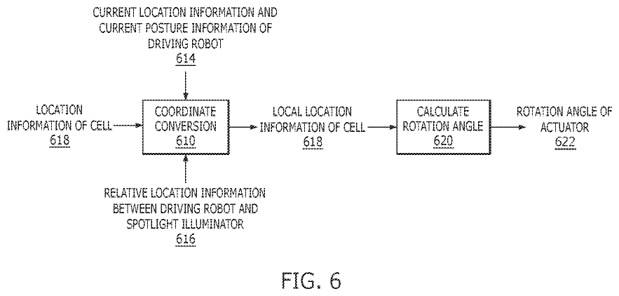

As described above, the control unit 350 may control the driving actuator 320, the spotlight illuminator 330, the illumination actuator 340, the barcode scanner 360, and the user interface 370. In addition, the control unit 350 may be configured to process the commands of the program for logistics management by performing basic arithmetic, logic, and input and output computations. For example, the control unit 350 may calculate local location information of a cell by performing coordinate conversion based on the location information of the location of the cell received via the transceiver 310. As another example, the control unit 350 may calculate a rotation angle of the illumination actuator 340 such that the pointing direction of the spotlight illuminator 330 corresponds to the location of the cell. A method for the control unit 350 to calculate the local location information of the cell or the rotation angle of the illumination actuator 340 will be described below in detail with reference to FIG. 6.

The barcode scanner 360 may be configured to scan a barcode attached to the target object, and the user interface 370 may include a physical operation button or a virtual button (e.g., a user interface element) displayed on a display or touch screen. The control unit 350 may receive barcode data associated with the target object through the barcode scanner 360 and/or receive a user input through the user interface 370, and perform appropriate process accordingly. For example, the control unit 350 may check, through the barcode data received from the barcode scanner 360, whether or not the target object is properly picked, and receive, through the user interface 370, a user input indicating the completion of picking the target object, and provide, via the transceiver 310 and the network, the received input to the information processing system.

The power supply unit 380 may supply energy to the driving robot 210 or to at least one internal component in the driving robot 210 to operate the same. For example, the power supply unit 380 may include a rechargeable battery. Additionally or alternatively, the power supply unit 380 may be configured to receive power from the outside and deliver the energy to the other components in the driving robot 210.

The driving robot 210 may include more components than those illustrated in FIG. 3. Meanwhile, most of the related components may not necessarily require exact illustration. The driving robot 210 may be implemented such that it may include an input and output device (e.g., a display, a touch screen, etc.) In addition, the driving robot 210 may further include other components such as a transceiver, a Global Positioning System (GPS) module, a camera, various sensors, a database, and the like. For example, the driving robot 210 may include components generally included in the driving robots, and may be implemented such that it may further include various components such as, for example, an acceleration sensor, a camera module, various physical buttons, and buttons using a touch panel.

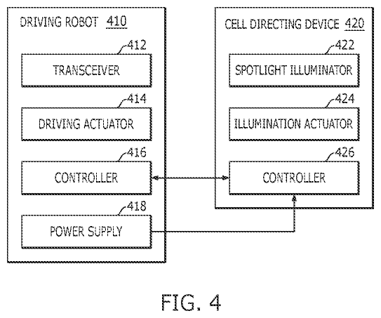

FIG. 4 is a block diagram of the internal configuration of a driving robot 410 and a cell directing apparatus 420. The driving robot 410 including a driving actuator 414, and the cell directing apparatus 420 including a spotlight illuminator 422 and an illumination actuator 424 may be configured as separate devices. In this case, the driving robot 410 and the cell directing apparatus 420 may be used in combination to assist the user with picking. For example, the driving robot 410 and the cell directing apparatus 420 may be connected by wire and used, or may be used while sharing information and/or data with each other through wireless communication. In this case, the producer and seller of the driving robot 410 and the cell directing apparatus 420 may be different.

Even when the driving robot 410 and the cell directing apparatus 420 are configured as separate devices, the internal configurations of the driving robot 410 and the cell directing apparatus 420 may be applied in the same or similar manner to those of FIG. 3 and the above description. In FIG. 4, the driving robot 410 and the cell directing apparatus 420 configured as separate devices from each other will be described mainly with reference to the differences.

The driving robot 410 may include a transceiver 412, the driving actuator 414, a control unit 416, and a power supply unit 418. Further, the cell directing apparatus 420 may include the spotlight illuminator 422, the illumination actuator 424, and a control unit 426. Additionally, the cell directing apparatus 420 may further include a transceiver (not illustrated) for communication with an external device and/or the driving robot 410. The control unit 426 may be configured to integrally perform the functions of the transceiver.

The power supply unit 418 of the driving robot may be configured to supply power to at least one internal component of the cell directing apparatus 420 (e.g., the control unit 426, the illumination actuator 424, the spotlight illuminator 422, etc. of the cell directing apparatus). In addition, the control unit 416 of the driving robot may be configured to control the driving actuator 414 and configured to transmit and receive information, data, and/or commands, etc. to and from the control unit 426 of the cell directing apparatus.

The control unit 426 of the cell directing apparatus may be configured to control the spotlight illuminator 422 and the illumination actuator 424, and configured to transmit and receive information, data, and/or commands, etc. to and from the control unit 416 of the driving robot.

For example, the control unit 426 of the cell directing apparatus may control the spotlight illuminator 422 and the illumination actuator 424 based on the data and/or commands provided from the control unit 416 of the driving robot. As a specific example, the control unit 416 of the driving robot may receive location information (coordinate values [x, y, z] in the global coordinate system) of a cell received from the information processing system (e.g., control server) via the transceiver 412. The control unit 416 of the driving robot may determine, by the control unit 426 of the cell directing apparatus, current location information and current posture information of the driving robot (that is, driving robot localization information [x, y, z, r, p, y] in the global coordinate system). The control unit 416 of the driving robot may calculate the location information of the determined cell, the current location information of the driving robot, the current posture information of the driving robot, and relative location information between the driving robot 410 and the cell directing apparatus 420 (for example, if the current location of the driving robot points to the current location of the driving actuator 414, the relative location information [x, y, z] between the driving actuator 414 and the spotlight illuminator 422), and local location information of the cell in the local coordinate system, which is the self-coordinate system of the driving robot (or the self-coordinate system of the cell directing apparatus 420), based on the current posture information ([r, p, y]) of the spotlight illuminator. The control unit 416 of the driving robot may calculate the rotation angle of the illumination actuator 424 based on the calculated local location information of the cell. The control unit 416 of the driving robot may transmit the calculated rotation angle of the illumination actuator 424 to the control unit 426 of the cell directing apparatus. The control unit 426 of the cell directing apparatus may control the illumination actuator 424 to rotate based on the received rotation angle of the illumination actuator 424.

As another specific example, instead of receiving the calculated rotation angle from the control unit 416 of the driving robot, the control unit 426 of the cell directing apparatus may receive the location information of the location of the cell, and the current location information and the current posture information of the driving robot from the control unit 416 of the driving robot, and directly calculate the local location information of the cell and/or the rotation angle of the illumination actuator 424. In this case, the control unit 426 of the cell directing apparatus may control the operation of the illumination actuator 424 based on the directly calculated rotation angle.

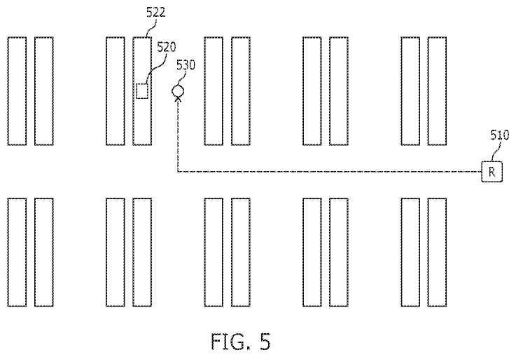

FIG. 5 illustrates an example in which a driving robot 510 equipped with a cell directing apparatus moves to a pickup location 530 to assist with picking of a target object 520. The distribution system may include a plurality of racks storing objects, and each rack may include a plurality of cells. That is, an object (or a plurality of objects) may be stored in each cell in the rack. Each rack and/or each cell may be located in a partitioned area and have unique location information (e.g., coordinate values in a global coordinate system). The driving robot 510 may receive, from the information processing system, the location information of the location of the cell having the target object 520 to be picked by the user.

The driving robot 510 may determine the pickup location 530 based on the location information of the location of the cell and may move to the determined pickup location 530 along the driving path. For example, the driving robot 510 may move to the pickup location 530 near a rack 522 including a cell having a target object. Alternatively, instead of determining the pickup location 530, the driving robot 510 may receive the pickup location 530 from the information processing system. When the driving robot 510 moves to the pickup location 530, the user may follow the driving robot 510 and move to the pickup location 530 together.

the driving robot 510 may arrive at the pickup location 530 and determine its current location information and current posture information. Alternatively, the information processing system may determine the current location information and the current posture information of the driving robot 510 based on data (e.g., depth image, color image, encoder value of the driving actuator, etc.) received from the driving robot 510, and transmit the information to the driving robot 510. The driving robot 510 may point at the cell having the target object 520 with spotlight illuminator based on the location information of the location of the cell having the target object, the current location information of the driving robot 510, and the current posture information of the driving robot 510 (if necessary, the relative location information between the driving robot 510 and the spotlight illuminator and the current posture information of the spotlight illuminator are further used). The current location information and/or the current posture information of the driving robot 510 may be information estimated by the driving robot 510 or information received by the information processing system.

Instead of finding the location of the cell by directly checking the location information of the location of the cell, the user may find the cell having the target object 520 more quickly and easily by visually checking the cell pointed to by the spotlight illuminator. In addition, instead of moving the rack 522 having the target object placed thereon near the location of the cell directing apparatus or the user, by moving the driving robot 510 equipped with the cell directing apparatus near the target object 520, it is possible to improve the efficiency of picking operation by utilizing the existing equipment without the need to replace the equipment.

FIG. 6 illustrates an example of a method for calculating a rotation angle 622 of an illumination actuator based on location information 612 of a cell. The control unit (e.g., at least one control unit of the driving robot and/or cell directing apparatus) may control the illumination actuator so that the spotlight points at the cell based on the location information 612 (coordinate values [x, y, z] in the global coordinate system) of the cell having the target object, the current location information and the current posture information 614 of the driving robot (localization information ([x, y, z, r, p, y]) of the driving robot in the global coordinate system), relative location information 616 ([x, y, z]) between the driving robot and the spotlight illuminator, and current posture information ([r, p, y]) of the spotlight illuminator.

The control unit may calculate local location information 618 of the cell by performing coordinate conversion 610 based on the location information 612 of the cell and the current location information and the current posture information 614 of the driving robot. For example, based on the location information 612 of the cell, which is the coordinate value of the cell in the global coordinate system, and based on the current location information of the driving robot in the global coordinate system and the current posture information 614 of the driving robot, the control unit may calculate the local location information 618 of the cell, which indicates the location of the cell having a target object, in a local coordinate system which is a self-coordinate system of the driving robot.

If the cell directing apparatus and the driving robot are configured as separate devices and the two devices are used in combination, the pointing direction of the spotlight illuminator may be changed according to the relative location information of the two devices. Therefore, if the cell directing apparatus and the driving robot are configured as separate devices, the control unit may calculate the local location information 618 of the cell by additionally considering the relative location information 616 between the driving robot and the spotlight illuminator. The relative location information 616 between the driving robot and the spotlight illuminator may include relative posture information between the driving robot and the spotlight illuminator.

The control unit may control the illumination actuator such that the spotlight illuminator points at the cell based on the calculated local location information 618 of the cell. The local location information 618 of the cell may be a local coordinate value indicating the location of the cell having the target object in the local coordinate system which is the self-coordinate system of the driving robot (or the cell directing apparatus or the spotlight illuminator). For example, the control unit may calculate 620 the rotation angle 622 of the illumination actuator based on the local location information 618 of the cell, and control the illumination actuator to rotate by the calculated rotation angle 622. The calculated rotation angle 622 may be a concept including a rotation direction.

Meanwhile, the rotation angle of the illumination actuator may vary according to the direction currently pointed to by the spotlight illuminator. Accordingly, the control unit may calculate the rotation angle 622 of the illumination actuator by further considering the current posture information of the spotlight.

The cell directing apparatus may include a plurality of actuators having different rotation axes. In this case, the control unit may calculate the rotation angle of each of the plurality of actuators, and control each of the plurality of actuators to rotate according to the calculated rotation angle. An example of the cell directing apparatus including a plurality of actuators will be described below in detail with reference to FIG. 7.

FIG. 7 illustrates an example of a cell directing apparatus. The cell directing apparatus may include a spotlight illuminator 750 configured to guide the location of the cell by illuminating the cell having the target object, and an illumination actuator configured to adjust the pointing direction of the spotlight illuminator 750. The spotlight illuminator 750 may be directly or indirectly connected to the illumination actuator such that the pointing direction may be changed according to driving of the illumination actuator. For example, a specific example of the cell directing apparatus including the illumination actuator and the spotlight illuminator 750 is illustrated in FIG. 7.

The cell directing apparatus may include a first actuator 710 configured to be rotated about a first rotation axis 712 and a second actuator 730 configured to be rotated about a second rotation axis 732.

The second actuator 730 may be connected to the first actuator 710 through a first connection part 720. Accordingly, it may be configured such that, if the first actuator 710 is rotated by a first rotation angle about the first rotation axis 712, the second actuator 730 is also rotated about the first rotation axis 712 by the first rotation angle.

In addition, the spotlight illuminator 750 may be connected to the second actuator 730 through a second connection part 740. Accordingly, it may be configured such that, as the first actuator 710 is rotated about the first rotation axis 712 by a first rotation angle and the second actuator 730 is rotated about the second rotation axis 732 by a second rotation angle, then the spotlight illuminator 750 is also rotated about the first rotation axis 712 by the first rotation angle and rotated about the second rotation axis 732 by the second rotation angle. That is, the spotlight illuminator 750 may be configured such that the pointing direction is adjusted to any direction in space according to the rotation angles of the first actuator 710 and the second actuator 730.

The control unit (e.g., the control unit of the driving robot or cell directing apparatus) may calculate the first rotation angle of the first actuator 710 and the second rotation angle of the second actuator 730 such that the pointing direction of the spotlight illuminator 750 corresponds to the location of the cell having the target object. Accordingly, the control unit may control the first actuator 710 and the second actuator 730 such that the first actuator 710 is rotated by the first rotation angle and the second actuator 730 is rotated by the second rotation angle, thereby controlling the spotlight illuminator 750 to point at the cell having the target object.

The cell directing apparatus illustrated in FIG. 7 is merely an example, and the scope of the present disclosure is not limited thereto. For example, the cell directing apparatus may be configured such that the spotlight illuminator 750 points at a cell having a target object according to driving of an illumination actuator rotatable in any direction in space.

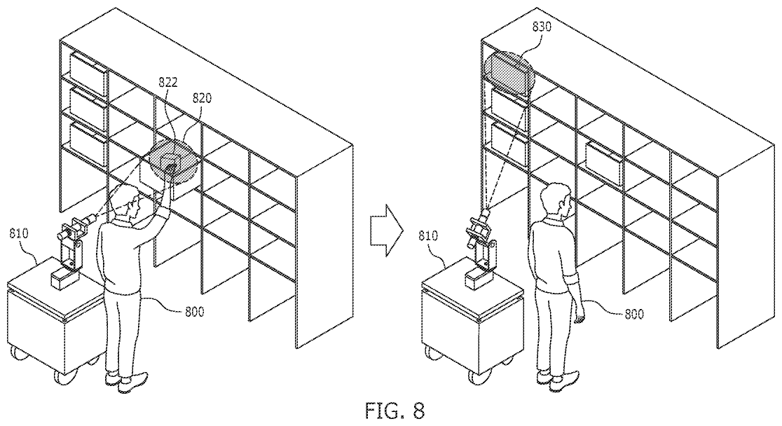

FIG. 8 illustrates an example in which a driving robot 810 equipped with a cell directing apparatus assists a user 800 with picking items. The driving robot 810 may stop at a pickup location and point at a cell 820 having a target object 822 with spotlight illuminator to assist the user 800 with picking. Instead of finding the location of the cell 820 by directly checking the location information of the location of the cell 820, the user 800 is able to find the cell having the target object 822 more quickly and easily by checking the cell 820 pointed to by the spotlight illuminator.

In response to receiving barcode data associated with the target object 822 from a barcode scanner (not illustrated) and/or receiving a user input through the user interface (not illustrated), the driving robot 810 may complete picking the target object 822. For example, the user 800 may take out the target object 822 and scan a barcode attached to the target object 822 through the barcode scanner. The user 800 may enter an input indicating the completion of picking the target object through the user interface. The driving robot 810 may check whether or not the target object 822 is properly picked, based on the barcode data received through the barcode scanner. In addition, the driving robot 810 may receive an input indicating the completion of picking the target object 822 from the user 800 through the user interface, and transmit information or signal indicating the completion of picking the target object 822 to the information processing system.

The information processing system may transmit the location of a cell 830 having the next target object to the driving robot 810 so that the driving robot 810 assists picking the next target object, or may transmit information or signal indicating the completion of the picking operation to the driving robot 810 so that the driving robot 810 ends the picking assisting operation.

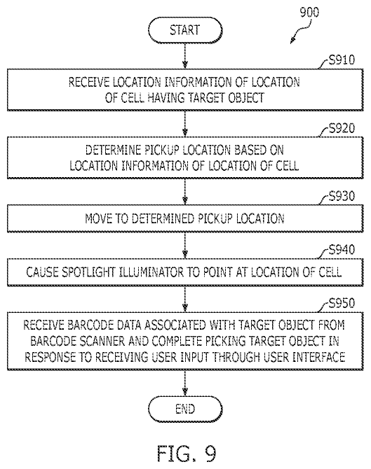

FIG. 9 is a flow diagram illustrating an example of a method 900 for assisting a user with picking. The method 900 may be initiated by a driving robot (e.g., a control unit of the driving robot) equipped with a cell directing apparatus, which receives location information of location of a cell having a target object to be picked by a user, at S910. For example, the driving robot may receive the location information of the location of the cell having the target object from the information processing system.

The driving robot may determine a pickup location based on the location information of the location of the cell at S920, and move to the determined pickup location at S930. For example, the control unit of the driving robot may determine the pickup location based on the location information of the location of the cell, and the driving robot may move to the pickup location near the target object through the driving actuator. Alternatively, instead of determining the pickup location, the driving robot may receive the pickup location from an external device capable of communicating with the driving robot and move to the pickup location.

The driving robot may cause the spotlight illuminator to point at the location of the cell having the target object, at S940. To this end, the driving robot may control the illumination actuator such that the spotlight illuminator points at the location of the cell. In addition, the driving robot may control the spotlight illuminator such that the spotlight illuminator is changed to on state. For example, the illumination actuator may include a first actuator configured to be rotated about a first rotation axis and a second actuator configured to be rotated about a second rotation axis. The driving robot may control the first actuator and the second actuator such that the first actuator is rotated about the first rotation axis by a first rotation angle and the second actuator is rotated about the second rotation axis by a second rotation angle. Accordingly, the pointing direction of the spotlight illuminator may be controlled to correspond to the location of the cell.

The driving robot may receive barcode data associated with the target object from the barcode scanner and complete picking the target object in response to receiving a user input through the user interface, at S950. For example, the user may take out the target object from the cell pointed to by the spotlight illuminator and scan a barcode attached to the target object through the barcode scanner. The user may enter an input indicating the completion of picking the target object through the user interface. Based on the barcode data received through the barcode scanner, the driving robot may check whether or not the target object is properly picked, and in response to receiving an input indicating the completion of picking the target object from the user through the user interface, transmit, to the information processing system, information or signal indicating the completion of picking the target object. The information processing system may transmit the location of the cell having the next target object to the driving robot so that the driving robot assists picking the next target object, or transmit information or signal indicating the completion of picking operation to the driving robot so that the driving robot ends the picking assisting operation.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, and so on. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A driving robot comprising:
a transceiver configured to communicate with an external device;
a driving actuator configured to the driving robot to move along a driving path;
a spotlight illuminator configured to guide a user to a location of a cell having a target object to be picked by the user;
an illumination actuator configured to adjust a pointing direction of the spotlight illuminator; and
one or more controllers configured to control the driving actuator, the spotlight illuminator, and the illumination actuator.

2. The driving robot according to claim 1, wherein the one or more controllers are further configured to:
receive location information of the location of the cell having the target object from the external device via the transceiver;
determine, based on the location information of the location of the cell, a pickup location; and
control the driving actuator such that the driving robot moves to the determined pickup location.

3. The driving robot according to claim 1, wherein the one or more controllers are further configured to:
receive location information of the location of the cell having the target object from the external device via the transceiver;
control the illumination actuator such that the spotlight illuminator points at the location of the cell based on:
the location information of the location of the cell,
current location information of the driving robot, and
current posture information of the driving robot; and
control the spotlight illuminator to on state.

4. The driving robot according to claim 3, wherein the current location information of the driving robot is location information estimated by the driving robot or the external device.

5. The driving robot according to claim 3, wherein the one or more controllers are configured to control the illumination actuator further based on relative location information between the driving actuator and the spotlight illuminator.

6. The driving robot according to claim 3,
wherein the one or more controllers are configured to control the illumination actuator further based on current posture information of the spotlight illuminator.

7. The driving robot according to claim 3, wherein:
the location information of the location of the cell comprises a coordinate value in a global coordinate system,
the current location information of the driving robot comprises a coordinate value in the global coordinate system, and
the one or more controllers are further configured to:
calculate local location information indicating the location of the cell having the target object in a local coordinate system which is a self-coordinate system of the driving robot, wherein the local location information is calculated based on the location information of the location of the cell, the current location information of the driving robot, and the current posture information of the driving robot; and
control the illumination actuator such that the spotlight illuminator points at the location of the cell based on the calculated local location information.

8. The driving robot according to claim 7, wherein the illumination actuator comprises:
a first actuator configured to be rotated about a first rotation axis under a control of the one or more controllers; and
a second actuator configured to be rotated about a second rotation axis under the control of the one or more controllers, and
wherein the one or more controllers are further configured to:
calculate a first rotation angle of the first actuator and a second rotation angle of the second actuator based on the calculated local location information;
rotate the first actuator by the first rotation angle; and
rotate the second actuator by the second rotation angle.

9. The driving robot according to claim 3, further comprising:
a barcode scanner; and
a user interface configured to receive a user input,
wherein the one or more controllers are further configured to:
after controlling the spotlight illuminator to the on state, receive barcode data associated with the target object from the barcode scanner, and
based on the user input, complete picking the target object.

10. A mobile cell directing apparatus comprising:
a spotlight illuminator configured to guide a user to a location of a cell having a target object to be picked by the user;
an actuator configured to adjust a pointing direction of the spotlight illuminator; and
one or more controllers configured to control the spotlight illuminator and the actuator,
wherein the one or more controllers are further configured to:
receive location information of the location of the cell having the target object from a driving robot;
receive current location information of the driving robot from the driving robot;
receive current posture information of the driving robot from the driving robot;
control the actuator such that the spotlight illuminator points at the location of the cell based on the location information of the location of the cell, the current location information of the driving robot, the current posture information of the driving robot, and information indicating a relative location of the mobile cell directing apparatus relative to the driving robot; and
control the spotlight illuminator to on state.
